(19) United States
(12) Patent Application Publication
(10) Pub. No.: US 2003/0010698 A1
(43) Pub. Date: Jan. 16, 2003

(54) Filter assembly components

(76) Inventor: Karl Fritze, Denmark Township, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/196,340

(22) Filed: Jul. 16, 2002

Related U.S. Application Data
(60) Provisional application No. 60/305,743, filed on Jul. 16, 2001.

(51) Int. Cl. B01D 27/00

(52) U.S. Cl. 210/235

(57) ABSTRACT

A filter assembly containing readily replaceable cartridge filters and a manifold that makes use of a dual seal to fluidly segregate a filtered water product from an unfiltered water source while also eliminating leakage outside the filter assembly. The dual seal consists of at least two seals located on an engagement surface on the cartridge filter. The first seal having an increased diameter over the second seal such that the second seal resides entirely within the first seal in a substantially concentric and coplanar orientation. Rotational installation of the cartridge filter brings the dual seals into physical contact with sealing surfaces located on the manifold creating a fluid tight seal.

### CLAIM TO PRIORITY

This application claims benefit of U.S. Provisional Application No. 60/305,743 filed Jul. 16, 2001, entitled, “FILTER ASSEMBLY COMPONENTS,” which is incorporated herein by reference.

### TECHNICAL FIELD

The present invention relates to components for mating a filter cartridge to a filter manifold. More particularly, the present invention relates to such components having at least two substantially concentric and substantially coplanar seals.

### BACKGROUND OF THE INVENTION

There is a need in the industry to provide replaceable filter cartridges that are readily matable to a filter manifold. The act of mating the replaceable filter cartridge to the filter manifold should effect a fluid tight seal as well as provide for separation of inlet unfiltered water from outlet filtered water.

### SUMMARY OF THE INVENTION

The filter assembly components of the present invention substantially meet the aforementioned needs of the industry. A cartridge having a cartridge top member of the present invention is readily matable to a manifold assembly having the manifold assembly component of the present invention. In effecting such mating, at least two substantially concentric and substantially coplanar seals provide first a water tight seal between the cartridge and the manifold and second, provide for effecting a seal between the unfiltered inlet water and the filtered outlet water to prevent contamination therebetween.

### BRIEF DESCRIPTION OF THE DRAWINGS

FIG. 1 is a top plan form view of the cartridge top member of the prevent invention;

FIG. 2 is a sectional view of the cartridge top member taken along section line 2-2 of FIG. 1 and including a sectional view of the manifold assembly component mated to the cartridge top member;

FIG. 3 is a perspective view of the cartridge top member;

FIG. 4 is a perspective view of the manifold assembly component; and

FIG. 5 is a perspective view of the manifold assembly component including a flow valve.

### DETAILED DESCRIPTION OF THE DRAWINGS

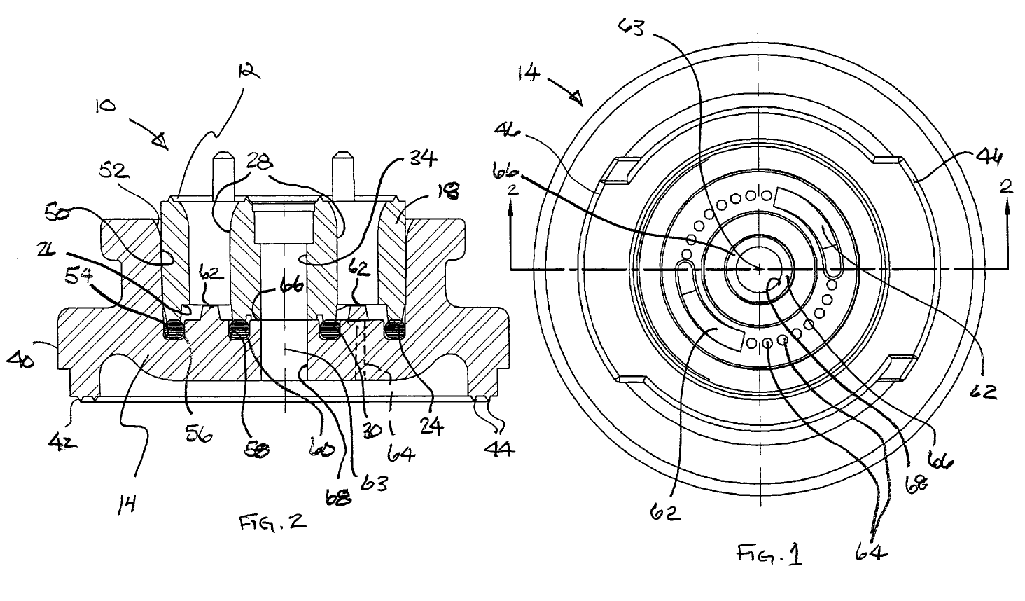

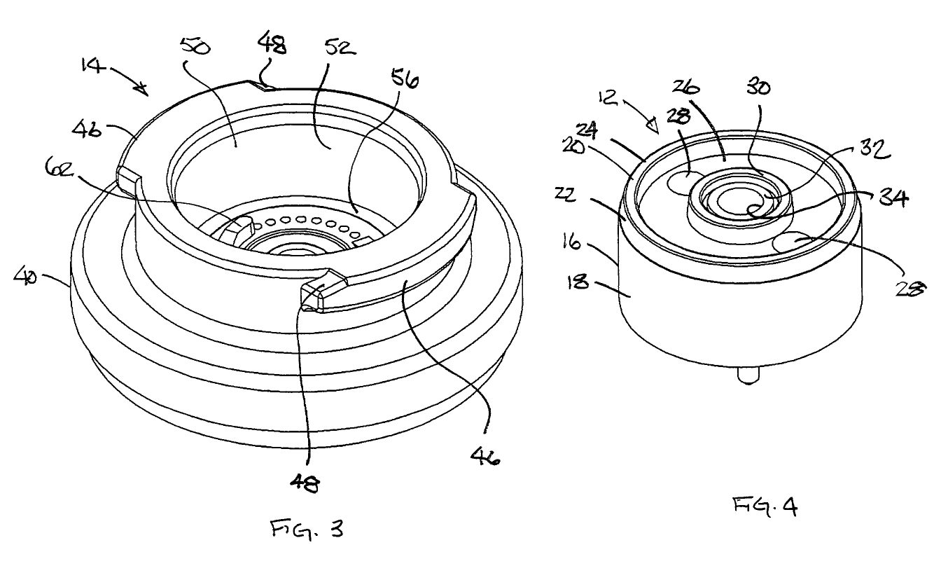

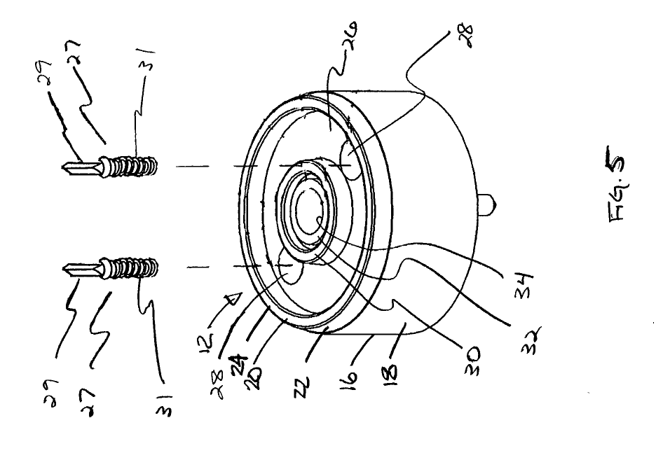

The filter assembly components of the present invention are shown generally at 10 in FIG. 2. The filter assembly components 10 include a manifold assembly component 12 and a cartridge top member 14. The manifold assembly component 12 is depicted in FIGS. 2 and 4. The cartridge top member 14 is depicted in FIGS. 1-3. It is understood that the cartridge top member 14 is intended to be fixedly mounted to a typically cup shaped cartridge housing (not shown). The cartridge housing is designed to contain a filter element for filtering water that passes through the filter element. The cartridge top member 14 is typically affixed to the cartridge housing by bonding such as sonic welding or spin welding.

Turning now to the manifold assembly component 12 of the filter assembly components 10, the manifold assembly component 12 has a body 16. The body 16 has a cylindrical outer margin 18. The upper margin of the cylindrical margin 18 defines a chamfered peripheral margin 20. The chamfered peripheral margin 20 has at least two faces, a chamfered face 22 and a first sealing face 24.

An inlet channel 26 is defined in an interior and depressed relationship to the sealing face 24. The inlet channel 26 is generally ring shaped. In an embodiment, a pair of inlet ports 28 extend through the manifold assembly component 12 and intersect inlet channel 26. As depicted in FIG. 5, an embodiment of manifold assembly component 12 may include a valve 27 having a depending valve stem 29 and a spring return 31. Valve 27 may be disposed in each of the inlet ports 28.

A second sealing face 30 is spaced apart from and interior to the first sealing face 24. The second sealing face 30 has a diameter that is less than the diameter of the first sealing face 24. A rim 32 interior to the sealing face 30 defines in part an outlet bore 34 that extends through the body 16.

The cartridge top member 14 of the filter assembly components 10 includes a body 40. The body 40 has a depending housing-engaging lip 42 for fixedly mating with the cartridge housing. In a preferred embodiment, the housing-engaging lip 42 has a pair of circular, pyramid shaped weld facilitators 44 depending therefrom.

A pair of outwardly directed shoulders 46 are disposed proximate the upper margin of the body 40. The shoulders 46 are diametrically opposed and each shoulder 46 may include a ramp 48 to facilitate engaging with an engaging member (not shown) of the manifold.

A receiver well 50 is defined depending from the upper margin of the body 40. The receiver well 50 has a substantially cylindrical side margin 52. A first seal groove 54 is defined at the bottom of the side margin 52. The first seal groove 54 is preferably circular in shape. A first seal 56, such as an O-ring seal, is disposed the first seal groove 54.

A second seal groove 58 is defined inward of the first seal groove 54. The second seal groove 58 is also preferably circular shaped having a diameter that is substantially less than the diameter of the first seal groove 54. A second seal 60, such as an O-ring seal, is disposed in the second seal groove 58. The first seal 56 and the second seal 60 are preferably spaced apart in a relationship concentric with the longitudinal axis 63 and are preferably coplanar, lying in a plane that is orthogonally disposed with relation to the axis 63.

A pair of diametrically opposed ramps 62 project upward between the two seals 56, 60. A plurality of inlet bores 64 are defined between the two ramps 62. The inlet bores 64 and the ramps 62 have substantially the same diameter.

An inlet bore extends through the body 40 and is defined in part by an inner lip 66. The inner lip 66 additionally defines, in part, the second seal groove 58.

In mating the cartridge top member 14 to the manifold assembly component 12, the manifold assembly 12 inserted into the receiver well 50 defined in the body 40 of the cartridge top member 14. The cartridge top member 14 is rotated relative to the manifold assembly component 12. Such rotation performs a number of functions. The shoulders 46 are engaged with manifold receivers (not shown) and the depending valve stem 29 of the valve 27 disposed in the inlet ports 28 rides up on the ramps 62 to open valve 27. With the opening of the valve 27, water flows through the inlet ports 28 to flood the inlet channel 26. In an alternative embodiment, an adapter could be used to facilitate interconnection of the cartridge top member 14 and the manifold assembly component 12. Such an adapter would allow for the use of filter assembly components 10 not originally designed for use with one another.

When fully mated, the sealing face 24 compressibly engages the first seal 56 preventing leakage of inlet water between the cylindrical margin 18 of the body 16 of the manifold assembly component 12 and the side margin 52 of the receiver well 50 of the body 40 of the cartridge top member 14. Further, the second sealing face 30 of the manifold assembly component 12 compressively engages the second seal 60 preventing unfiltered inlet water from leaking from the inlet channel 26 to contaminate filtered water in the outlet bores 34, 68. In this manner, two concentric, coplanar seals 56, 60 effectively prevent leakage from the filter assembly components 10 and further prevent leakage between the inlet ports 28, inlet bores 64 and the outlet bores 34, 68.

Although the present invention has been described with reference to a preferred embodiment, workers skilled in the art will recognize that changes may be made in form and detail without departing from the spirit or scope of the present invention.

1. A filter assembly for the filtration of water from an external source, the filter assembly including a manifold assembly mountable to an appliance and being in fluid communication with the external source and a cartridge assembly, the cartridge assembly being replaceably fluidly couplable to the manifold assembly, the filter assembly comprising:
at least a first seal and a second seal cooperating to provide a fluid tight seal during engagement of the manifold assembly with the cartridge assembly, the first seal having a larger diameter than the second seal such that the second seal resides entirely within the first seal in a substantially concentric, coplanar orientation, the second seal serving to prevent contamination of a filtered water product with the external source and the first seal serving to prevent leakage outside the filter assembly.

2. The filter assembly of claim 1 wherein the cartridge assembly is rotatably couplable to the manifold assembly.

3. The filter assembly of claim 1 wherein the manifold assembly includes a flow valve within an inlet channel supplying the external source.

4. The filter assembly of claim 3 wherein the flow valve is dispositioned to fail in a normally closed orientation.

5. The filter assembly of claim 4 wherein the flow valve interfaces with a projection on an engagement surface of the cartridge assembly.

6. The filter assembly of claim 1 wherein the first seal and the second seal are o-rings.

7. The filter assembly of claim 1 wherein the first seal and the second seal are integrally molded to the cartridge assembly.

8. A cartridge filter for use in the filtration of water from an external source, the filter being replaceably fluidly couplable to a manifold assembly, the filter comprising:
an engagement surface, the engagement surface including at least a first seal and a second seal, the first seal having a larger diameter than the second seal such that the second seal resides within the first seal in a substantially concentric, coplanar configuration.

9. The cartridge filter of claim 8 wherein the engagement surface includes a pair of diametrically opposed tabs providing for rotational engagement with the manifold assembly.

10. The cartridge filter of claim 9 wherein the diametrically opposed tabs include a guiding surface for facilitating engagement with the manifold assembly.

11. The cartridge filter of claim 8 wherein the first seal and the second seal are o-rings.

12. The cartridge filter of claim 8 wherein the first seal and the second seal are integrally molded with the engagement surface.

13. The cartridge filter of claim 8 wherein the engagement surface includes a circular, ramping projection.

14. The cartridge filter of claim 13 wherein the ramping projection interfaces with a projecting flow valve located on the manifold assembly.

15. A cartridge filter for use in the filtration of water from an external source, the filter including an engagement surface for connection to a manifold assembly, the filter comprising:
means for allowing rotational interconnection of the filter and manifold assembly; and
means for forming a substantially concentric, coplanar seal for separation of a filtered water product and an unfiltered water source.

16. A method for creating a fluid tight seal in a water filter assembly, the seal preventing contamination of a filtered water product with an unfiltered water source, the method comprising:
providing a cartridge filter, the cartridge filter including an engagement surface, the engagement surface including at least a pair of diametrically opposed tabs, the engagement surface further including at least a first seal and a second seal, the first seal having a larger diameter than the second seal such that the second seal resides within the first seal in a substantially concentric, coplanar configuration;
providing a manifold assembly, the manifold assembly including a projecting cylindrical surface, the projecting cylindrical surface including an internal ramp assembly; and
physically interconnecting the filter and the manifold assembly, the opposed tabs cooperating with the internal ramp assembly to rotationally approximate the filter and the manifold assembly, approximation of the filter and the manifold assembly causing the first seal and the second seal to sealingly engage the filter and the manifold assembly.

17. The method of claim 16 including forming the first seal and the second seal of o-rings.

18. The method of claim 16 including integrally molding the first seal and the second seal.

19. An adapter for use with a filter assembly for the filtration of water of water from an external source, the filter assembly including a manifold assembly mountable to an appliance and being in fluid communication with the external source and a cartridge assembly, the cartridge assembly being replaceably fluidly couplable to the manifold assembly, the adapter comprising:
means for sealingly mating to the cartridge assembly, and
means for mating to the manifold assembly having at least a first seal and a second seal cooperating to provide a fluid tight seal during engagement of the manifold assembly with the cartridge assembly, the first seal having a larger diameter than the second seal such that the second seal resides entirely within the first seal in a substantially concentric, coplanar orientation, the second seal serving to prevent contamination of a filtered water product with the external source and the first seal serving to prevent leakage outside the filter assembly.

20. The adapter of claim 19 wherein the cartridge assembly is rotatably couplable to the adapter.

21. The adapter of claim 19 wherein the manifold assembly includes a flow valve within an inlet channel supplying the external source.

22. The adapter of claim 21 wherein the flow valve is dispositioned to fail in a normally closed orientation.

23. The adapter of claim 22 wherein the flow valve interfaces with a projection on an engagement surface of the adapter.

24. The adapter of claim 19 wherein the first seal and the second seal are o-rings.

25. The adapter of claim 19 wherein the first seal and the second seal are integrally molded to the cartridge assembly.

26. A manifold assembly for use in a filter assembly for the filtration of water of water from an external source, the filter assembly including the manifold assembly being mountable to an appliance and being in fluid communication with the external source and a cartridge assembly, the cartridge assembly being replaceably fluidly couplable to the manifold assembly, the manifold assembly comprising:
mating means for cooperative sealing mating with a cartridge assembly, the cartridge assembly having at least a first seal and a second seal cooperating to provide a fluid tight seal during engagement of the manifold assembly with the cartridge assembly, the first seal having a larger diameter than the second seal such that the second seal resides entirely within the first seal in a substantially concentric, coplanar orientation, the second seal serving to prevent contamination of a filtered water product with the external source and the first seal serving to prevent leakage outside the filter assembly.

27. The manifold assembly of claim 26 wherein the cartridge assembly is rotatably couplable to the manifold assembly.

28. The manifold assembly of claim 26 wherein the manifold assembly includes a flow valve within an inlet channel supplying the external source.

29. The manifold assembly of claim 28 wherein the flow valve is dispositioned to fail in a normally closed orientation.

30. The manifold assembly of claim 29 wherein the flow valve interfaces with a projection on an engagement surface of the cartridge assembly.

31. The manifold assembly of claim 26 wherein the first seal and the second seal are o-rings.

32. The manifold assembly of claim 26 wherein the first seal and the second seal are integrally molded to the cartridge assembly.
